(19) United States
(12) Patent Application Publication
(10) Pub. No.: US 2014/0139803 A1
(43) Pub. Date: May 22, 2014

(54) Ophthalmic lenses with melanin and ocular lens pigment having low fluorescence

(71) Applicants: James M. Gallas, San Antonio, TX (US); Mark A. Penick, San Antonio, TX (US); John-Paul Lozano, San Antonio, TX (US)

(72) Inventors: James M. Gallas, San Antonio, TX (US); Mark A. Penick, San Antonio, TX (US); John-Paul Lozano, San Antonio, TX (US)

(73) Assignee: Photoprotective Technologies, Inc., San Antonio, TX (US)

(21) Appl. No.: 13/998,371

(22) Filed: Oct. 25, 2013

Related U.S. Application Data
(60) Provisional application No. 61/795,808, filed on Oct. 25, 2012.

(51) Int. Cl. G02C 7/10

(52) U.S. Cl. CPC G02C 7/10
USPC 351/159.62

(57) ABSTRACT

Fluorescence as a new source of haze caused by the light-filtering agent in ophthalmic lenses is introduced. A transparent ophthalmic lens comprising melanin as the light filtering agent with reduced fluorescence from melanin is described and the techniques used to quench the melanin fluorescence.

This application cross references a Provisional Patent Application 61/795,808 of the same title filed Oct. 25, 2012

### BACKGROUND

Prior art has described the light-filtering benefits of melanin (Gallas, U.S. Pat. Nos. 4,698,374; 5,112,883; 5,036,115; 5,047,447) and also ocular lens pigment (also called OLP—or SLP) derived from 3 hydroxy Kynurenine (U.S. Pat. No. 6,825,975) as well as the methods for incorporation of these pigments into various plastics. A primary benefit of melanin and OLP-based lenses for the consumer is protection against photochemical damage to the eye from exposure to sunlight and to artificial light.

Another benefit of lenses with melanin or OLP is the reduction of glare and eyestrain. Both of these benefits derive from the selective filtration of UV and HEV (high energy visible) light by melanin and by OLP. Here, selective filtration means the particular way in which melanin and OLP transmit the various wavelengths of light.

For example, photochemical damage generally increases with photon energy, or with wavelength according to Planck's law for radiation:

E=hc/1.

Still another benefit of lenses or light filters with melanin is their ability to transmit nearly 100% of the near infrared (IR) light which may induce repair of cells and provide therapy to tissue.

A typical transmission spectrum of melanin is shown in FIG. 1. which shows that melanin's ability to filter light has a wavelength dependence also in accord with the Planck law and in accord with action spectra for photochemical damage for a variety of organic and biological molecules. It also shows the high transmission of potentially therapeutic near IR light.

Glare experienced by humans also increases with decreasing wavelength in a manner similar to photochemical damage: It has been established that fluorescence of the human lens, activated by UV and HEV (high energy visible) light, is a primary source of discomfort glare because this light impinges upon the retina with no image content; it could be characterized as simply a ‘glow’ of light internal to the eye cavity—in other words, glare. Thus, lenses with melanin are able to effectively reduce the risks of both ocular damage and ocular glare because melanin lenses reduce the intensity of the light in the UV and HEV-wavelength region most responsible for activating the fluorescence of the lens of the eye.

It is an essential point of this invention that there is, however, a problem with the current art relating to the melanin used to make commercial lenses so far. Because ophthalmic lenses are primarily made with polymer resins, and because most polymer resins are hydrophobic, it has been necessary to convert the inherently-hydrophilic melanin to a hydrophobic melanin—as taught in U.S. Pat. No. 5,112,883—in order to achieve adequate dispersion of melanin or OLP in plastic lenses that subsequently have low haze.

A primary method for converting hydrophilic melanin into a hydrophobic form is the method of derivatization. And applicants have now found that the process of derivatizing melanin causes a significant increase in its fluorescence. So, it is desirable to reduce both haze due to light scatter and haze due to fluorescence in ophthalmic lenses containing melanin.

### BRIEF SUMMARY OF THE INVENTION

There is a problem with the current art relating to the melanin used to make commercial ophthalmic lenses. In order to produce cast ophthalmic lenses with melanin well-dispersed and having low haze, there is a need to convert the inherently-hydrophilic melanin into hydrophobic melanin. Typically, this is achieved with chemical modification such as derivatization.

However, Applicants have found unexpectedly that lenses made with derivatized melanin acquire an enhanced fluorescence—which is undesirable because such fluorescence introduces a new source of glare for consumers who wear lenses made with derivatized melanin. Applicants have also found ways to significantly lower this fluorescence and yet retain the hydrophobic character required for melanin to disperse in most commercial processes used to manufacture ophthalmic lenses with adequately low haze—nominally below 1%.

In addition, Applicants here teach fluorescence in ophthalmic lenses—that are tinted with dyes—as a type of haze; and Applicants therefore put forth concern for fluorescence on similar footing as the concern for haze from light scatter that is monitored routinely today as part of quality control by manufacturers of ophthalmic lenses. Though many sun lenses on the market do not fluoresce, some do; and their contribution to haze can be significant and can randomly infect the optical quality of ophthalmic lenses purchased by consumers. Furthermore, the two types of haze are fundamentally different because the fluorescence emission wavelengths are shifted from the excitation wavelength; whereas the wavelength of the light scatter associated with haze is the same as the excitation wavelength. Without this observation, haze due to light scatter will not be systematically discriminated from haze due to fluorescence. Applicants therefore propose that fluorescence measurements be included by lenses makers—along with haze measurements—as part of the quality control process, and that lenses that do contain fluorescent dyes be purposely modified chemically or physically to quench the fluorescence intensities to values below 1%—just as haze from light scatter.

### DETAILED DESCRIPTION OF THE INVENTION

### Figures

FIG. 1. The transmission spectrum of a melanin lens. FIG. 1 shows low transmission of damaging UV and HEV light; the transmission is ‘selective’—increasing steadily for the longer, safer wavelengths light; transmission of the therapeutic light is 100%.

FIG. 2. A melanin ophthalmic lens (Layer 2) containing a melanin copper ion complex to quench the melanin fluorescence; and a surface coating (Layer 1) containing a UV absorber to minimize the secondary fluorescence of the melanin-copper ion complex.

FIG. 3a. Example of Melanin as a mixture of related oligomers produced by oxidative oligomerization of phenols. Melanins corresponding to the structure of FIG. 4a. have R₁-R₄ independently selected from H, OH, carboxyl, aryl and substituted aryl.

FIG. 3b. Example of Melanin as a mixture of related oligomers produced by oxidative oligomerization of phenols. Where now R₁-R₄ are independently selected from: H, OH, halogen, alkyl, alkoxy, haloalkyl, aryl, hydroxyaryl, halogenated hydroxyaryl, aryl groups bearing R groups of their own [independently selected from the first 9 members of this list], and aryloxy groups bearing R groups of their own [independently selected from the first 9 members of this list].

FIG. 4. Example structures for a hypothetical representative catechol melanin showing halogenation of the phenolic portion of the underivatized melanin molecules via oxidation with excess sodium bromated

FIG. 5. Representative general structure of a catechol-derived melanin after derivatization by a chloroformate.

FIG. 6. Example structures for a hypothetical representative catechol melanin showing complexation with Copper (II)

FIG. 7a. Example structures for a hypothetical representative catechol melanin showing halogenation of the phenolic portion of the underivatized melanin molecules via an electrophilic halogen sources, in this case N-bromosuccinimide.

FIG. 7b. Example structures for a hypothetical representative catechol melanin showing halogenation of the phenolic portion of the underivatized melanin molecules via'an electrophilic halogen sources, in this case N-iodosuccinimide.

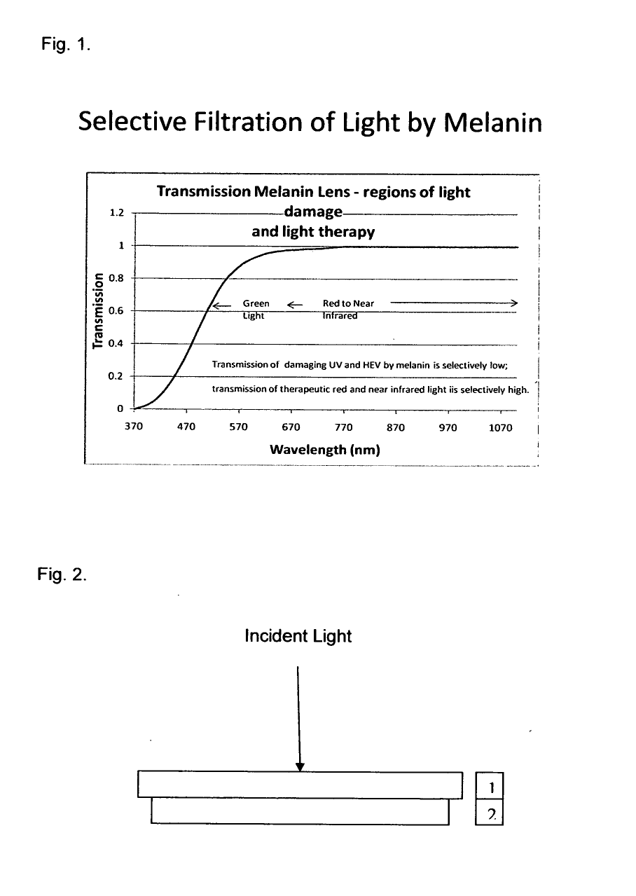

### DEFINITIONS

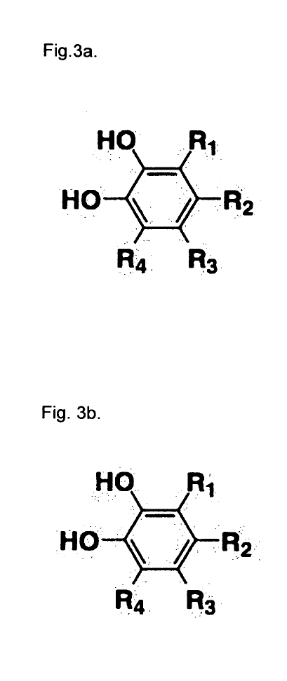

1. Melanin is a mixture of related oligomers produced by oxidative oligomerization of phenols. Melanins corresponding to the structure of FIG. 3a. have R₁-R₄ independently selected from H, OH, carboxyl, aryl and substituted aryl. Melanin may be further defined as described in detail in the review by Wakamatsu and Ito in ‘Advanced Chemical Methods in Melanin Determination, in Pigment Cell Res. 15:174-183 (2002) whose work is incorporated here in its entirety.

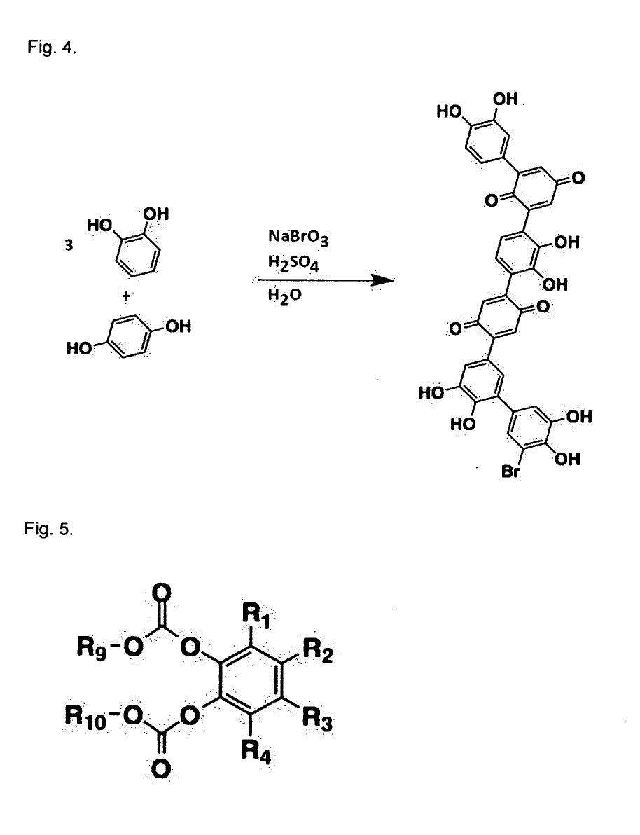

2. Derivatized melanins are defined in this applications as hydrophilic melanins, synthesized by the normal techniques of autooxidation in water and then subsequently made to react with agents that react with the hydroxyl groups of the melanin surface and impart a hydrophobic character to the modified melanin and as described in more detail in U.S. Pat. No. 5,112,883. See FIG. 4.

3. Standard Derivatized Melanin means melanin that is synthesized or derivatized in the standard manner (described in US Pat. 5,112,883) with no specific attempts to minimize or quench the fluorescence.

4. Partially-derivatized melanin means that the process of derivatizing melanin was executed as described more fully in U.S. Pat. No. 5,112,883; however, the concentration of the derivatizing agent is reduced relative the standard amount resulting in more free hydroxyl/phenolic units along the perimeter of the melanin oligomers. Partially derivatized melanin is less hydrophobic but is also less fluorescent because of quenching by proton transfer from the relatively higher concentration of free hydroxyl groups in such partially derivatized melanins.

5. Haze Associated with Fluorescence means the contribution to haze or light scatter as measured by a haze meter when the excitation wavelength is filtered before the light scatter

6. Low fluorescent, low haze means Melanins synthesized or derivatized so as to result in melanins with low fluorescence and low haze that are suitable for use in ophthalmic plastic light filters.

7. Low fluorescence, low haze melanin means melanins processed so that their haze in transparent plastics is below 1%. (Also see the description below in ‘Fluorescence Tests.’)

8. OLP or Ocular Lens Pigment means the biological material responsible for the coloration in the human lens and also described in U.S. Pat. No. 6,825,975).

Melanin is a complex group of oligomeric fractions of different sizes, shapes and surface chemistry. Its structure is not well understood and the basis for its fluorescence is also not well understood. An inherently-nanometer-sized oligomer, melanin is long-known to aggregate into micron-sized particles which display excessive Mie-type light scatter. In aqueous media, such un-derivatized, melanin can be well dispersed—meaning it has very low light scatter in the visible region of wavelengths,—provided optimum environmental conditions are present. Such good dispersion is due in part to the ionizable groups present on the surface of the melanin oligomer. While some melanin precursors used to synthesize melanin have carboxyl- and amine-type ionizable groups, all have hydroxyl or phenolic groups and which occur in the product of the oligomerization.

At relatively high pH values, melanin dispersion is good; but at low pH values or when chelating, divalent metal ions are present, then aggregation of melanin occurs. This same underivatized melanin does not disperse in organic or non-polar solvents in general.

U.S. Pat. No. 5,112,883 has taught that the tendency for melanin to aggregate persists when it is dispersed in ophthalmic lenses made of hydrophobic polymers—even when the melanin is derivatized.

Thus, haze is known to exist perennially at some level in melanin lenses by those skilled in the art within the patent literature and within the ophthalmic lens industry. Generally, such haze is measured with a haze meter whose source is broad-band wavelength light—light that could be the source of both light scatter and light that could activate fluorescence. Applicants have found unexpectedly that when blue light impinges upon plastic lenses containing derivatized melanin, a glow occurs with an appearance similar to light scatter but which has a color that is shifted away from blue and toward colors associated with longer wavelengths in accord with fluorescence. Thus, while derivatized melanin might still tend to aggregate and cause haze in plastics—although to a lesser degree than non-derivatized melanin—it also appears to fluoresce.

So, on one hand, lenses with melanin selectively reduces UV and HEV light and thereby reduces the glare-causing fluorescence of the human lens; but on the other hand, the process of making melanin suitable for achieving dispersion and low haze in plastic lenses—through derivatization—actually introduces a new source of glare caused by the fluorescence of the derivatized melanin.

Applicants therefore propose to reduce the fluorescence of derivatized melanin fluorescence using several techniques described below. Applicants also propose to reduce the fluorescence of underivatized melanins that are synthesized so as to incorporate atoms or molecules that render the melanin both low in fluorescence and more hydrophobic. In all cases, such melanins are to have haze values due to fluorescence below 1% in ophthalmic lens.

### Addition of Fluorescence Quenchers

Techniques for the quenching of fluorescence in molecules are well-known to those skilled in the art. These include, but are not limited to, excited state reactions, energy transfer, complex-formation and collisional quenching and quenching by heavy atoms and molecules and ions such as molecular oxygen and iodide. However, applying such techniques to melanin are problematic or untoward because of the chemical and physical nature of melanin itself. For example, heavy atoms are known to quench fluorescence, and specifically redox metal ions are known to quench the fluorescence of melanin; however, redox metal ions are also well-known to cause aggregation of melanin and therefore can cause unwanted haze.

Likewise, the stacking of melanin moieties or monomers is also known to quench fluorescence; but again, stacking is associated with aggregation of melanin and thus leads to unwanted haze.

It is also known that highly de-aggregated melanin—caused by oxidation, for example—is highly fluorescent relative to aggregated melanin.

Thus one object of this invention is to quench the fluorescence of melanin for incorporation into lenses made with hydrophobic polymers (injection-molded or cast thermo-set).

A second object of this invention is to quench fluorescence without causing aggregation that leads to haze associated with light scatter.

A third object of this invention is to shift any fluorescence from the visible wavelengths to wavelengths that are not in the visible range.

A fourth object of the present invention is the preservation of the relatively high transmission of therapeutic, Near IR light in the region between 700 nm and 1400 nm.

### Melanin Fluorescence

Melanin fluorescence is known to be low in its normal hydrophilic state. This is the state of melanin when it is synthesized from a variety of known precursors using standard oxidizers such as hydrogen peroxide, molecular oxygen and a variety of inorganic persulfates and provided the pH is maintained sufficiently high during synthesis—but not too high to cause bleaching. Small angle X-ray scattering has been used to show that under these conditions, the melanin particles (called oligomers) are well-dispersed—meaning their sizes are below 10 nanometers, and therefore they do not scatter visible light

This same melanin—subjected to further oxidation and at an elevated pH—can be made to be highly fluorescent. It is also known that highly oxidized melanin is highly de-aggregated and de-stacked—as well as partly degraded.

Some of the scientific literature suggests that the oxidative degradation of melanin is the cause of its enhanced fluorescence, while other reports suggest that the de-aggregation of melanin is the cause of its enhanced fluorescence.

In the present case of derivatized melanin, where we have discovered an enhanced fluorescence, this enhanced fluorescence is not likely to be the result of extra oxidation because there was not any extra oxidation during or following the synthesis of the melanin. Instead, the enhanced fluorescence was the direct consequence of the derivatization. This derivatization—as described in U.S. Pat. No. 5,112,883—is believed to occur by way of nucleophilic reaction between the derivatizing agents used and the phenolic moieties of the polyquinone/polyphenolic melanin oligomers. Thus derivatization of melanin by agents such as chloroformates replaces phenols with carbonates, for example, and proton transfer—a possible means of inherent quenching of the fluorescence of non-derivatized, hydrophilic melanin on these parts of the melanin oligomers—is no longer operative. Furthermore, stacking to form quionhydrone-type complexes—another form of fluorescence quenching, possibly Foster-type—is also precluded by such derivatization.

Melanin fluorescence is known to be quenched by iodine and by complexation with copper ions. In the case of copper ions, the fluorescence of melanin in the visible part of the spectrum is significantly reduced while there is an increase in fluorescence in the UVA part of the spectrum.

Finally, it has been reported that structural changes in melanin can occur from exposure to near IR which, in turn can lead to an increase in fluorescence, it would seem reasonable to reduce the transmission of near IR. However, Gallas has taught—in a pending application—that biomolecular repair and tissue therapy can occur from this same exposure. Thus it is desirable to allow the transmission of near IR light through any lens that contains melanin.

It is therefore clear that no definitive explanation exists in the scientific literature for the basis for melanin fluorescence—in its enhancement or in its reduction (quenching). Based upon our own findings summarized and disclosed in this application, the Applicants take the following position regarding the achievement of the objects of this invention:
a) the presence of hydroxyl groups found generally in the melanin structure impart a hydrophilic character;
b) in order to achieve good dispersion and low haze in ophthalmic lenses chemical modification (derivatization) of the hydroxyl groups has been taught (U.S. Pat. No. 5,112,883)—to impart a more hydrophobic character to the melanin particles;
c) the presence of hydroxyl groups on the melanin oligomer may be a significant quenching mechanism for melanin fluorescence.

Applicants therefore describe the following preferred embodiments to the current invention:

### PREFERRED EMBODIMENTS

### First Preferred Embodiment

It is a preferred embodiment of this application that a hydrophobic, low fluorescent melanin is made by chemical modification of the melanin during its synthesis.

It is an essential point of this invention that proton transfer by melanins in the excited state is an important mechanism for providing radiationless transitions and that retention of the hydroxyl groups is effective in order to provide a melanin with low fluorescence as our First Preferred Embodiment. Applicants have found that it is possible to modify the melanin structure so that fluorescence is significantly reduced and still have low haze in plastic resin by incorporating heavy atoms into the rings structure of the melanin during its synthesis. See FIG. 3b.

### EXAMPLE 1

A non-derivatized, brominated melanin with low fluorescence was prepared as follows: 150 grams of catechol and 50 grams of hydroquinone were dissolved in 6 liters of deionized water and 97 mLs of concentrated sulfuric acid added. A water bath was placed around the flask 91.4 g of sodium bromate was dissolved in 1 L of water. The sodium bromate solution was added to the other. The reaction quickly turned black and a strong exotherm ensued. The reaction mixture was stirred until this subsided and the temperature fell [2 hours 20 minutes]. The melanin was collected by vacuum filtration, washed several times with deionized water and allowed to air dry. 111.6 grams of a black solid [fraction 1] was obtained.

32.25 grams of sodium bromate was dissolved in 350 mL of deionized water and added to the filtrate. A reaction quickly ensued, with a weak exotherm. After about 1.5 hours of stirring the reaction mixture was vacuum filtered. The melanin was collected by vacuum filtration, washed several times with deionized water and allowed to air dry. 36.9 grams of a black solid [fraction 2] was obtained.

20 mLs of concentrated sulfuric acid was added to the filtrate. 50 grams of sodium bromate was dissolved in 550 mL of deionized water and added to the filtrate. A reaction quickly ensued, with almost no exotherm, and bromine vapor appeared above the reaction mixture. The reaction was stirred until most of the bromine disappeared [about 1.5 hours]. The melanin was collected by vacuum filtration, washed several times with deionized water and allowed to air dry, giving 58.6 g of a brown solid [fraction 3]. See FIG. 4.

### EXAMPLE 2

10 miligrams of the powder of Example 1 was dispersed in 10 ml of methylmethacrylate by stirring for 30 minutes. 300 milligrams of benzoyl peroxide was then added with stirring and then poured into a mold to form a circular plaque and placed in an oven at 65 degrees C. and allowed to cure for 180 minutes.

### EXAMPLE 3

10 miligrams of the powder of Example 1 was dispersed in a two part polyurethane system by stirring for 60 minutes and then poured into a mold to form a circular plaque and placed in an oven at 70 degrees and allowed to cure for 6 hours.

### EXAMPLE 4

250 milligrams of the powder of Example 1 was compounded with 200 grams of polymethylmethacrylate at 230 degrees C. and injected into a mold to form a plaque.

### Second Preferred Embodiment

Melanin-Metal ion Complexes. Chelates and ligands of redox or transition metal ions with melanin.

It is possible to form complexes with melanin—un-derivatized or partially derivatzed—wherein the fluorescence of the new complex is less than or considerably less than the fluorescence of the non-complexed melanin. In addition, an essential point of this embodiment is that the fluorescence emission of the complex could also fall in a wavelength region outside of the visible region so that the fluorescence cannot contribute to glare.

It has previously been shown (Gallas, Ph.D dissertation) that copper ions form complexes with melanin in aqueous media such that the fluorescence emission decreases throughout the visible region of wavelengths as the molar concentration of copper ions increases—relative to the molar concentration of the melanin. At the same time, a new fluorescent band occurs with a peak maximum at 400 nm for excitation wavelengths throughout the UVB and UVA region of wavelengths. As a function of concentration, the emission spectra for various copper ion concentrations—including zero concentration of copper ions—reveal an iso-emissive point confirming the formation of s complex.

Applicants thus propose the addition of copper ions to melanin in order to significantly reduce the fluorescence of melanin in the visible part of the spectrum. Applicants recognize that there is a corresponding increase in the fluorescence of the melanin-copper ion complex. This emission, at first seems objectionable as a new source of glare because the emission at 400 nm would serve as an excitation for fluorescence of the chromophores in the lens of the eye and this contribute to glare. However, this fluorescence is deemed very weak because its excitation is of secondary intensity—coming itself from fluorescence. And whatever emission by the new complex is transmitted through the lens of the eye, it will not be detected by the retina because the rods and cones are not sensitive to this region of wavelengths. Finally, for such complexes proposed here by the applicants, it is also proposed by the applicants that standard UV absorbers—commonly used by lens makers and those skilled in the art to filter UV—will be incorporated into coatings for the front surface of all melanin lenses considered in this application. Thus, the overall effect of using melanin-copper ion complexes in ophthalmic lenses—along with UV compounds in the lens surface coatings as shown in FIG. 2—is to reduce the fluorescence-based glare from the melanin and any fluorescence from the complex.

Such complexes maybe stable during one of the subsequent derivatization processes. The copper-melanin complexes can also be formed subsequent to derivatization where the derivatized melanin is in an organic solvent such as dichloromethane or tetrahydrofuran and is mixed with a thermoset monomer resin. Because the degree of derivatization of the melanin can be controlled stoichiometrically it is possible to have remaining free phenolic moieties to which chelation with copper ions could occur. It is also feasible for the copper ions to form ligands with the carboxyl groups associated with the melanin oligomer.

### EXAMPLE 5

150 milligrams of melanin powder prepared by derivatization with a chloroformate as follows: 10 grams of catechol melanin is dissolved in 150 mililiters of tetrahydrofuran; to this solution 26 mls of triethylamine is added dropwise while stirring and followed by dropwise addition of 26 mls of ethylchloroformate. See FIG. 5. The reaction is allowed to stir for 3 hours, filtered, and washed with water; the derviatized THF melanin solution was dried over sodium sulfate and injected into a hexane to form a powder.

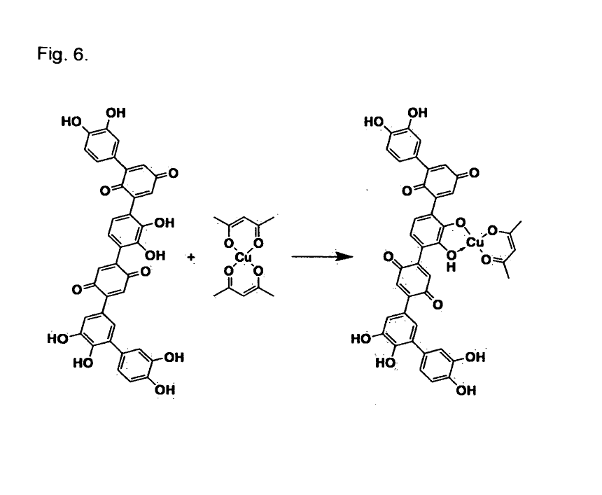

150 milligrams of the powder was added to 5 milliliters of tetrahydrafuran to form a stock solution. 40 micro liters of the stock solution was added to 10 ml of methyl methacrylate The solution was divided into two equal 5 mL parts and kept in 20 mL glass vials. To one of the vials was added 0.050 grams of Copper (II) acetylacetonate and stirred. See FIG. 6.

Finally, quenching of fluorescence may also arise through energy transfer (FRET) from the melanin oligomer to the copper-melanin complexes that forms through an operating distance (d) in the 2 nm to 4 nm range.

### Third Preferred Embodiment

### Incorporation of Heavy Atoms into the Melanin Structure—Melanin Halogenation

The halogenation of underivatized melanin molecules derived from catechol or other phenols may be accomplished with existing reagents that are recognized as electrophilic halogen sources by those skilled in the art of organic chemistry. These include but are not limited to N-bromosuccinimide, N-iodosuccinimide, or iodine monochloride. The halogen atoms will be attached to electron-rich portions of the melanin molecule, which will be the existing aromatic moieties. The attachment process is mechanistically the same as electrophilic aromatic substitution, familiar to those skilled in the art, and results in replacement of one or more of the hydrogen atoms on the hydroquinone moieties of the melanin molecules, with either bromine or iodine, depending on the reagent used.

### EXAMPLE 6

2.01 grams of melanin from fraction 1 of Example 1 was dissolved in 30 mL tetrahydrofuran. 10 mL of water was added, followed by 9 drops of 50% aqueous NaOH. A solution of 740 mg of N-bromosuccinimide in 10 mL tetrahydrofuran was added and the mixture stirred for about 3 hours. The mixture was then acidified with 30% aqueous H₂SO₄, followed by addition of solid Na₂SO₄ to cause the water and tetrahydrofuran to separate. The tetrahydrofuran solution was dried over 4 changes of Na₂SO₄ and filtered.

At least one halogen atom is needed to initiate intersystem crossing; but in reactions of this type, some of the melanin molecules will likely contain more than one halogen atom. Applicants believe that the melanin molecules are sufficiently large so that aromatic moieties on one side will not be affected by halogenation at the other side, and so remain reactive.

### EXAMPLE 7

Another way of attaching iodine is to use molecular iodine in the presence of an oxidizing agent. The oxidizing agent is employed because when 12 is used as the iodine source, one iodine atom is attached to the substrate (melanin, in this case), and the other becomes I⁻ or HI. The problem with the side products is that they can drive the reaction backwards and take the iodine back off. However, if an oxidizing agent is added, they get converted back to 12 and are used again in the reaction. 2.01 grams of melanin from fraction 1 of Example 1 was dissolved in 30 mL tetrahydrofuran. 10 mL of water was added, followed by 9 drops of 50% aqueous NaOH. A solution of 740 mg of N-iodosuccinimide in 10 mL tetrahydrofuran was added and the mixture stirred for about 3 hours. The mixture was then acidified with 30% aqueous H₂SO₄, followed by addition of solid Na₂SO₄ to cause the water and tetrahydrofuran to separate. The tetrahydrofuran solution was dried over 4 changes of Na₂SO₄ and filtered.

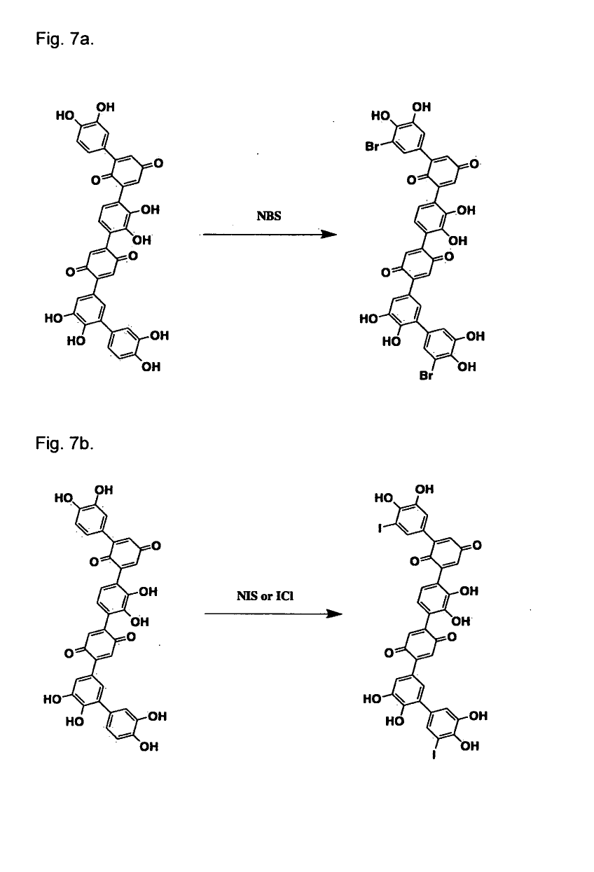

Examples of these reactions are shown in FIG. 7a and in FIG. 7b for a hypothetical representative catechol melanin.

### Fourth Preferred Embodiment

Applicants recognize that another possible means of quenching the fluorescence of melanin is by incorporating the quencher molecule into the derivatizing agent. The quencher part of the derivatizing agent could include a heavy atom such as iodide or it could be an acceptor type molecule that could facilitate resonance energy transfer between the excited fluorophore (the melanin) and the acceptor in which there is overlap between the melanin fluorescence emission (the part in the visible region of wavelengths) and the absorption spectrum of the acceptor molecule (also in the visible region of wavelengths).

### EXAMPLE 8

### BPCF Derivatization

400 mg of melanin from fraction 1, Example 1 was dissolved on 83 mL of tetrahydrofuran and 1.2 mL of triethylamine was added. 1.7 mL of 4-bromophenyl chloroformate was added to this mixture.

The solution was stirred for about two hours, then washed with aqueous sodium sulfate, and dried over solid sodium sulfate. After precipitation in heptane and drying, 330 mg was obtained.

### Fifth Preferred Embodiment

Partial derivitization of brominated melanin. It is possible to achieve lower fluorescence and hydrophobic character to melanin by simply carrying out a partial derivatization of melanin. This approach has the object of specifically retaining some of the hydroxyl groups that help to quench fluorescence at the risk of retaining the hydrophiloic character that is need to overcome in order to achieve good dispersion and low haze.

### EXAMPLE 9

1.54 grams of brominated melanin from Fraction 3, Example 1 was dissolved in 30 mL of dry tetrahydrofuran and 1.05 mL of triethylamine was added, followed by 1.05 mL of phenyl chloroformate. The reaction was filtered and the melanin precipitated by adding the solution to 5 times its volume of n-heptane. The melanin was redissolved in ethyl acetate/tetrahydrofuran and washed 3 times with water containing Na₂SO₄, followed by drying over Na₂SO₄. The solution was filtered and the melanin precipitated by adding the solution to 5 times its volume of n-heptane. The suspension was filtered and allowed to dry.

### Fluorescence Tests

Fluorescence test of two types—solutions and substrates—were performed on the melanin products of the preceding examples.

Plaques were made from the melanins made in the preceding examples. Solutions in liquid thermoset resins were also made from these melanins. The samples were placed into a fluorescence apparatus. This device consists of a collimated blue LED light source, an integrating sphere with small entrance and exit ports on opposite ends of the sphere diameter, a photo-diode located inside the sphere, a digital multimeter, and a pivotable mirror located just outside the exit port of the integrating sphere. With the plaques placed perpendicular to the LED beam and between the LED light source and the entrance port of the sphere, ‘the ratio of the scattered beam intensity to the intensity of the non-scattered beam’ (haze) was determined by a series of voltage readings, with and without the sample in place: exit port opened and exit port closed (mirror pivoted to reflect the exit beam back into the integrating sphere). In order to differentiate between haze due to light scatter and haze due to fluorescence, a yellow light filter was also placed between the melanin samples and the entrance port of the integrating sphere—thereby allowing only the fluorescent light to reach the inside of the integrating sphere. Haze values due to the fluorescent light was nominally less than 1%.

The present invention identifies fluorescence as a source of glare in melanin lenses for the first time and also distinguishes this fluorescence from light scatter which is an important and current issue in the art of modified melanins designed for use in ophthalmic lenses. Other techniques besides the examples discussed above—and that are well known to those skilled in the art—may also be used to quench the fluorescence of derivatized melanin. These include broadly: Collisional (dyanamic) and static—with both type requiring contact between the quencher molecule and the fluorophore; and resonance energy transfer (no direct contact). IR region of wavelengths.

With regard to possible increases in the fluorescence of melanin caused by exposure to the near IR, one possible solution to such an event is the use of coatings on the melanin lens that contain near IR absorbers. However, this is undesirable because applicants recognize that the near IR is very likely to provide therapy to the eye and melanin and OLP have an inherently high transmission of near IR. Instead, the applicants propose to

Functionalize the melanin or OLP (as described in U.S. Pat. No. 5,112,883) so that co-polymerization with any thermoset resins can provide sequestration and preclude such structural changes.

I claim:

1. A transparent ophthalmic lens comprising a dye or pigment, wherein said dye or pigment have been chemically modified to reduce the fluorescence or phosphorescence of said dye or pigment.

2. A transparent ophthalmic lens comprising melanin or ocular lens pigment, wherein said melanin and ocular lens pigment have been chemically modified to reduce the fluorescence or phosphorescence of said melanin and ocular lens pigment.

3. A transparent ophthalmic lens according to claim 2, wherein the melanin or the ocular lens pigment are modified by incorporation of heavy atoms into the melanin structure to reduce the fluorescence or phosphorescence.

4. A transparent ophthalmic lens according to claim 2, wherein the melanin or the ocular lens pigment are modified by incorporation of heavy atoms into the aromatic rings of the melanin structure to reduce the fluorescence or phosphorescence.

5. A transparent ophthalmic lens according to claim 2, wherein the melanin or the ocular lens pigment are modified by complexation with quencher molecules to reduce the fluorescence or phosphorescence.

6. A transparent ophthalmic lens according to claim 2, comprising a derivatized melanin or a derivatized ocular lens pigment, wherein said melanin and ocular lens pigment have been modified to reduce their fluorescence or phosphorescence.

7. A transparent ophthalmic lens according to claim 2, comprising melanin or ocular lens pigment, wherein said melanin and ocular lens pigment have been modified to reduce their fluorescence or phosphorescence by halogenations of the melanin or ocular lens pigment.

8. A transparent ophthalmic lens comprising melanin or ocular lens pigment, wherein said transparent ophthalmic lens is coated with a front layer that contains a UV absorber in order to minimize the fluorescence or phosphorescence of the melanin and ocular lens pigment.
